(19) United States
(12) Patent Application Publication
(10) Pub. No.: US 2023/0136422 A1
(43) Pub. Date: May 4, 2023

(54) Advanced Commercial Electrolysis of Seawater to Produce Hydrogen

(71) Applicant: Rodolfo Antonio Gomez, South Australia (AU)

(72) Inventor: Rodolfo Antonio Gomez, South Australia (AU)

(21) Appl. No.: 17/918,145

(22) PCT Filed: Apr. 12, 2021
(86) PCT No.: PCT/AU2021/000032

§ 371 Date: Oct. 11, 2022

(30) Foreign Application Priority Data
Apr. 12, 2020 (AU) 2020901163

(51) Int. Cl. C25B 1/04; C25B 9/70; C25B 9/17; C25B 11/089; C25B 11/052; C25B 11/061; C25B 11/065; C25B 9/19; C25B 9/65; C25B 1/50

(52) U.S. Cl. CPC C25B 1/04; C25B 9/70; C25B 9/17; C25B 11/089; C25B 11/052; C25B 11/061; C25B 11/065; C25B 9/19; C25B 9/66; C25B 1/50

(57) ABSTRACT

An apparatus for electrolysing seawater to produce hydrogen is disclosed. The apparatus includes a unipolar electrolytic cell configured to operate in cathode-cathode mode and configured to reduce the production of chlorine and/or oxygen.

### CROSS REFERENCE TO RELATED APPLICATIONS

This application is the United States national phase of International Application PCT/AU2021/000032 filed Apr. 12, 2021, and claims priority to Australian Provisional Patent Application No. 2020901163 filed Apr. 12, 2020, the disclosures of which are hereby incorporated by reference in their entireties.

### INCORPORATION BY REFERENCE

The following publications are referred to in the present application and their contents are hereby incorporated by reference in their entirety:
Australian Patent 2008209322;
United Kingdom Patent GB2460000;
Chinese Patent ZL200880012716;
South African Patent 2011/04916;
Hong Kong Patent HK1137408; and
U.S. Pat. No. 10,316,416.

### BACKGROUND OF THE INVENTION

### Field of the Invention

The present disclosure relates to the production of hydrogen from seawater.

### Description of Related Art

Hydrogen energy produced from hydrogen and has many uses such as fuel for transport or heating or as a way to store electricity. Hydrogen is an important part of a clean and secure energy future for most countries.

Hydrogen can be produced using a number of different processes. Thermochemical processes use heat and chemical reactions to release hydrogen from organic materials such as fossil fuels and biomass. Microorganisms such as bacteria and algae can produce hydrogen through biological processes. Alternatively, water can be split into hydrogen and oxygen using electrolysis or solar energy.

The present applicant has previously developed a process that involves the unipolar electrolysis of seawater to produce hydrogen (see, for example, Australian Patent 2008209322). Whilst this technology has been proven to work and hydrogen can be produced from seawater, it can also result in the concurrent production of oxygen and/or chlorine which can be problematic.

There is a need to provide an electrolytic system for the production of hydrogen from seawater that minimises the production of chlorine and/or oxygen.

### SUMMARY OF THE INVENTION

According to a first aspect, there is provided an apparatus for electrolysing seawater to produce hydrogen, the apparatus comprising a unipolar electrolytic cell configured to operate in cathode-cathode mode and configured to reduce the production of chlorine and/or oxygen.

In certain embodiments, the apparatus is configured to reduce the production of chlorine and/or oxygen by reducing the voltage at the cathode and/or anode.

In certain embodiments, the apparatus comprises one or more resistors to reduce the voltage at the cathode and/or anode.

In certain embodiments, the apparatus comprises:
a cathode cell comprising a cathode electrode and a cathode cell solution electrode;
an anode cell comprising an anode electrode and an anode cell solution electrode;
wherein cell gaps between the cathode electrode and a cathode cell solution electrode and the anode electrode and an anode cell solution electrode are set to reduce the voltage at the cathode and/or anode.

In certain embodiments, the apparatus comprises:
multiple anode cells connected in series, each anode cell having a gap between electrodes; and
multiple cathode cells connected in series, each cathode cell having a gap between electrodes
wherein the gap between electrodes in the cathode cell is larger than the gap between electrodes in the anode cell.

In certain embodiments, the cathode cells and the anode cells are diaphragm-less electrolytic cells connected in cathode mode.

In certain embodiments, the cathode cells and the anode cells are fitted with low electrical resistance electrodes coated with at least one catalyst.

In certain embodiments, the apparatus comprises diaphragm-less electrolytic cells where there are more anode cells with smaller gaps between electrodes and less cathode cells with larger gaps between the electrodes.

In certain embodiments, the apparatus comprises five anode cells with electrode gaps of 4 mm and four cathode cells with electrode gaps of 6 mm

In certain embodiments, the electrodes of the diaphragm-less electrolytic system are made of high electrical conductivity material and coated with a protective coating and/or a catalyst coating. The high electrical conductivity material may be selected from the group consisting of copper and graphene. The catalyst coating may comprise Hastelloy 276c. The protective coating may comprise ruthenium/iridium metal or and oxide thereof.

In certain embodiments, the apparatus comprises a cathode cell and an anode cell and a membrane between the anode cell and the cathode cell, the membrane configured to allow only electrons to pass from cathode cell to the anode cell resulting in the cathode electrolyte becoming electrically negative while the anode electrolyte becoming electrically positive and further comprising another set of electrolytic cells through which the electrically negative cathode electrolyte and the electrically positive anode electrolyte can be passed to generate a current and produce hydrogen and oxygen.

In certain embodiments, the cathode-cathode mode comprises an electrical connection where the negative of a DC supply is connected to the cathode electrode, the cathode solution electrode connected to the anode electrode and the positive of the DC supply is connected to the anode solution electrode.

According to a second aspect, there is provided a process for producing hydrogen from seawater, the process comprising introducing seawater into an apparatus according to the first aspect and producing hydrogen therefrom.

### BRIEF DESCRIPTION OF THE DRAWINGS

Embodiments of the present disclosure will be discussed with reference to the accompanying drawings wherein:

FIG. 1 is a schematic diagram of a prior art Unipolar electrolysis apparatus as described in, for example, Australian Patent 2008209322;

FIG. 2 is a schematic diagram of an electrolysis apparatus according to an embodiment of the present disclosure that can be used to produce hydrogen from seawater;

FIG. 3 is a schematic diagram of an electrolysis apparatus according to a further embodiment of the present disclosure that can be used to produce hydrogen from seawater;

FIG. 4 is a schematic diagram of an electrolysis apparatus according to an embodiment of the present disclosure that can be used for the commercial production of hydrogen from seawater;

FIG. 5 is a schematic diagram of an electrolysis apparatus according to a further embodiment of the present disclosure that can be used for the commercial production of hydrogen from seawater; and

FIGS. 6(A-C) are schematic diagrams of an electrolysis apparatus according to an embodiment of the present disclosure that utilises a membrane cell and can be used for the commercial production of hydrogen from seawater.

In the following description, like reference characters designate like or corresponding parts throughout the figures.

### DESCRIPTION OF THE INVENTION

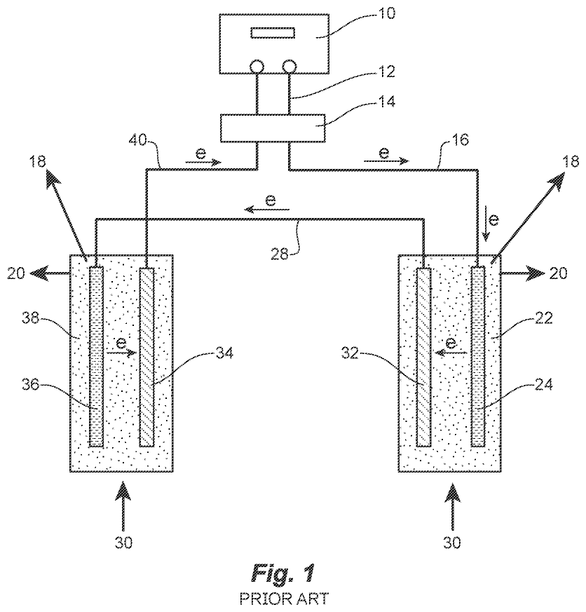

The present applicant has been granted Australian Patent 2008209322, United Kingdom Patent GB2460000, Chinese Patent ZL200880012716, South African Patent 2011/04916 and Hong Kong Patent HK1137408 for a process that involves the Unipolar electrolysis of seawater to produce hydrogen. The apparatus disclosed in these patents is shown in FIG. 1. Briefly, the apparatus comprises a DC power supply 10 in electrical connection with a modulator 14. The modulator is in electrical connection with a cathode cell 22 and an anode cell 38. The cathode cell 22 comprises a cathode electrode 24 and a solution electrode 32. The anode cell 38 comprises an anode electrode 36 and a solution electrode 34. The anode cell 38 acts as a cathode. The components of the apparatus are connected by electrical wires 12, 16, 28 and 40. Seawater 30 is introduced into each cell 22, 38 and hydrogen 18 and alkaline seawater 20 are produced at the cathode cell 22 and the anode cell 38.

A problem with Unipolar electrolysis apparatus and process depicted in FIG. 1 is that at the cathode cell 22, if the cell voltage exceeds 0.828 volts, oxygen and chlorine may be produced and at the anode cell 38, if the voltage exceeds 0.401 volts, oxygen and chlorine may be produced at the cathode cell 22. This limitation in voltage reduces the capacity of the system to produce pure hydrogen 18 as shown in Table 1.

TABLE 1
Projection of voltage in the Unipolar electrolysis of seawater

Gap at Anode, mm 4.8675
Gap at Cathode, mm 10.0506

| Cell Voltage | Anode Volts | Cathode Volts | Total Volts | Overvoltage |
|---|---|---|---|---|
| 1.229 | 0.401 | 0.828 | 1.229 | 0 |
| 1.3 | 0.424 | 0.876 | 1.3 | 0.071 |
| 1.4 | 0.457 | 0.943 | 1.4 | 0.171 |
| 1.5 | 0.489 | 1.011 | 1.5 | 0.271 |
| 1.6 | 0.522 | 1.078 | 1.6 | 0.371 |
| 1.7 | 0.555 | 1.445 | 1.7 | 0.471 |
| 1.8 | 0.587 | 1.213 | 1.8 | 0.571 |
| 1.9 | 0.620 | 1.280 | 1.9 | 0.671 |
| 2 | 0.653 | 1.347 | 2 | 0.771 |
| 2.1 | 0.685 | 1.415 | 2.1 | 0.871 |
| 2.2 | 0.718 | 1.482 | 2.2 | 0.971 |
| 2.3 | 0.750 | 1.550 | 2.3 | 1.071 |
| 2.4 | 0.783 | 1.617 | 2.4 | 1.171 |
| 2.5 | 0.816 | 1.684 | 2.5 | 1.271 |
| 2.6 | 0.848 | 1.752 | 2.6 | 1.371 |
| 2.7 | 0.881 | 1.819 | 2.7 | 1.471 |
| 2.8 | 0.914 | 1.886 | 2.8 | 1.571 |
| 2.9 | 0.946 | 1.954 | 2.9 | 1.671 |
| 3 | 0.979 | 2.021 | 3 | 1.771 |

There is a need for apparatus and processes that will allow higher rates of production of pure hydrogen 18 from the electrolysis of seawater 30 by allowing a higher cell voltage without producing any substantial amounts of chlorine or oxygen.

Disclosed herein is an apparatus for electrolysing seawater 30 to produce hydrogen 18. The apparatus comprises a unipolar electrolytic cell configured to operate in cathode-cathode mode and configured to reduce the production of chlorine and/or oxygen.

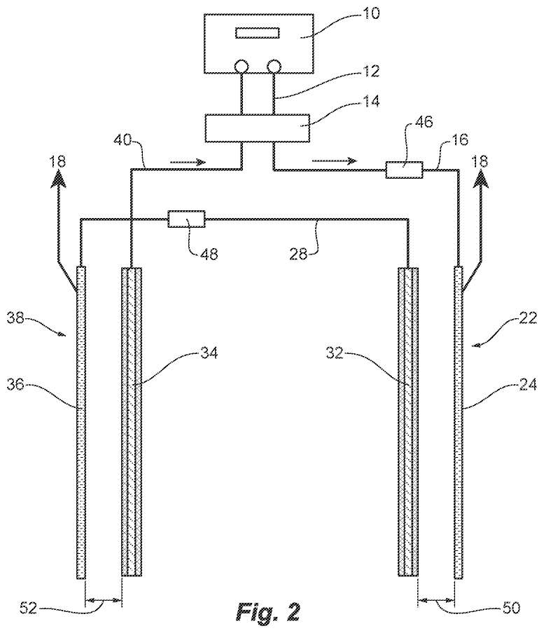

In certain embodiments of the present disclosure shown in FIG. 2, the apparatus comprises a resistor at the cathode or anode circuit to reduce the voltage at the cathode or anode and prevent chlorine or oxygen being produced. The apparatus comprises a DC power supply 10 in electrical connection with a modulator 14. The modulator is in electrical connection with a cathode cell 22 and an anode cell 38. The cathode cell 22 comprises a cathode electrode 24 and a solution electrode 32. The anode cell 38 comprises an anode electrode 36 and a solution electrode 34. The components of the apparatus are connected by electrical wires 12, 16, 28 and 40. Hydrogen 18 is produced at the cathode cell 22 and the anode cell 38 in the same way as it is produced in the Unipolar electrolysis apparatus shown in FIG. 1. In the embodiment shown in FIG. 2, resistor 46 is positioned before the cathode cell 22 and resistor 48 is positioned before the anode call 38. The resistors 46, 48 are able to reduce the voltage at the cathode 22 and the anode 38 respectively to minimise or prevent production of chlorine or oxygen at each cell.

In the embodiment shown in FIG. 2 the cell voltage is 2.1 volts but the voltage across the cathode cell 22 is 0.828 volts with resistor 46 taking 0.222 volts based on a current of 100 amperes. At the anode cell 38, resistor 48 takes 0.65 volts so that the cell voltage across the anode cell 38 is 0.401 volts. The cell gaps 50 and 52 at the cathode 22 and anode 38 respectively are 6 mm.

Resistors are inefficient as they consume power without producing hydrogen. Therefore, in certain other embodiments of the present disclosure, the cell gaps at the cathode and the anode are used to reduce the voltage at the cathode or anode and prevent chlorine or oxygen being produced. The voltage across a cell is directly proportional to the gap between the cathode or anode electrode and the corresponding solution electrode. In the prior Unipolar electrolysis apparatus shown in FIG. 1 and described in, for example, Australian Patent 2008209322, the cell gap at the anode cell is 4.8675 mm and the cell gap at the cathode is 10.0506 mm. It will be appreciated that, as used herein, the term “cell gap” means the spacing between two electrodes in an electrolytic cell, such as the spacing between anode electrode 36 and anode cell solution electrode 34 in anode cell 38 or the spacing between cathode electrode 24 and cathode cell solution electrode 32 in cathode cell 22. In embodiments of the present disclosure, the cell gaps 50 and 52 at the cathode 22 and anode 38 respectively are 6 mm. It will be appreciated that other cell gaps, such as about 4 mm, about 4.5 mm, about 5 mm, about 5.5 mm, about 6 mm, about 6.5 mm, about 7mm, about 7.5 mm or about 8 mm can be used. It will be appreciated that the best gap for the anode 36 and the cathode 24 electrodes for a particular apparatus can be determined empirically.

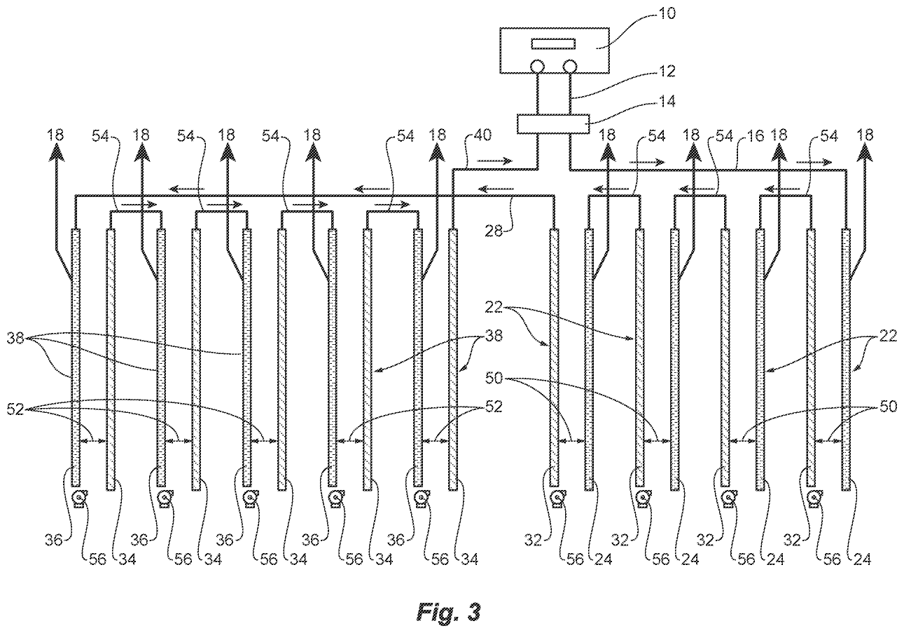

In certain other embodiments of the present disclosure, a reduction in total cell voltage is achieved without increasing the cell voltages of the anode and the cathode by installing cathode and anode cells in series. This allows a higher total cell voltage without increasing the cathode or anode cell voltage that may result in producing unwanted chlorine or oxygen. This embodiment is shown in FIG. 3 which shows five anode cells 38 with cell gaps 52 of 4 mm and four cathode cells 22 with cell gaps 50 of 6 mm. As with FIG. 2, each anode cell 38 comprises an anode electrode 36 and a solution electrode 34 and each cathode cell 22 comprises a cathode electrode 24 and a solution electrode 32. The cathode electrodes 24 can be any suitable electrode material such as Pt/Ir (90:10) coated on titanium mesh. The solution electrodes 32 can be any suitable material such as Ir/Ru or Mo/Co/Mn on titanium. The apparatus in FIG. 3 also comprises a DC power supply 10 in electrical connection with a modulator 14 which, in turn, is in electrical connection with the cathode cells 22 and the anode cells 38. The components of the apparatus are connected by electrical wires 12, 16, 28, 40 and 54.

Seawater is pumped into each cell at 200 lpm via valves 56 and hydrogen 18 is produced at each cathode cell 22 and each anode cell 38.

With a total cell voltage of 4 volts, the predicted voltage at the anode cells 38 is 0.36 volts while at the cathode cells 22 the predicted cell voltage is 0.545 volts. The predicted voltages are based on the total gaps 52 at the anode cells 38 and the total gaps 50 at the cathode cells 22. Table 2 shows the cell voltages with the total cell voltage at 4 volts.

TABLE 2
Voltage with multiple anode and cathode cells

Gap at Cathode, mm 6
Gap at Anode, mm 4

| Cell Voltage | Anode Volts | Cathode Volts | Total Cell V |
|---|---|---|---|
| 1.229 | 0.559 | 0.670 | 1.229 |
| 1.3 | 0.591 | 0.709 | 1.300 |
| 1.4 | 0.636 | 0.764 | 1.400 |
| 1.5 | 0.682 | 0.818 | 1.500 |
| 1.7 | 0.773 | 0.927 | 1.700 |
| 1.8 | 0.818 | 0.982 | 1.800 |
| 1.9 | 0.864 | 1.036 | 1.900 |
| 2 | 0.909 | 1.091 | 2.000 |
| 2.1 | 0.955 | 1.145 | 2.100 |
| 2.2 | 1.000 | 1.200 | 2.200 |
| 2.3 | 1.045 | 1.255 | 2.300 |
| 2.4 | 1.091 | 1.309 | 2.400 |
| 2.5 | 1.136 | 1.364 | 2.500 |
| 2.6 | 1.182 | 1.418 | 2.600 |
| 2.7 | 1.227 | 1.473 | 2.700 |
| 2.8 | 1.273 | 1.527 | 2.800 |
| 2.9 | 1.318 | 1.582 | 2.900 |
| 4 | 1.818 | 2.182 | 4.000 |

5 Anode and 4 Cathode Cells- no resistors

In certain embodiments, the electrode material is made from high electrical conductivity material such as copper or graphene.

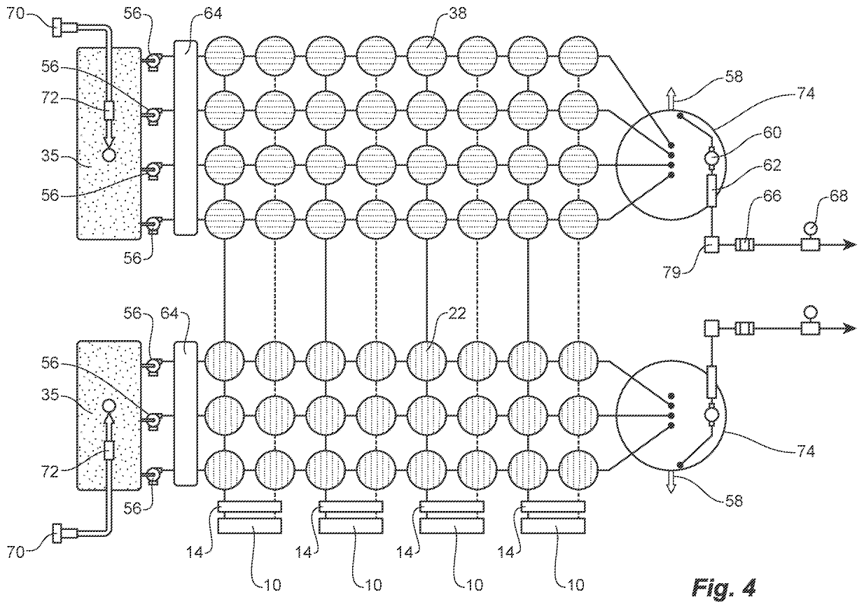

An arrangement of cells in a commercial plant for electrolysing seawater and producing only pure hydrogen is shown in FIG. 4. This technology also produces alkaline seawater that can sequester carbon dioxide. This will assist carbon polluting plants like coal power plants and cement plants using coal or natural gas to sequester their carbon emissions. The apparatus shown in FIG. 4 comprises three sets of cathode cells 22 and four sets of anode cells 38. Each set of cathode cells 22 and anode cells 38 is electrically connected to a DC power supply 10 in electrical connection with a modulator 14 which, in turn, is in electrical connection with the cathode cells 22 and the anode cells 38. In the embodiment illustrated in FIG. 4 there are eight sets of cathode 22 and anode 38 cells. It will be appreciated that the number of sets of cathode 22 and anode 38 cells can be varied.

Seawater 30 is fed into the apparatus of FIG. 4 via seawater pump 70. The seawater passes through a filter 72 and into pump box 35. From pump box 35 the seawater 30 passes via valve 56 and control panel 64 into the bottom of each cathode cell 22 and each anode cell 38. Hydrogen 18 produced at each cell 22, 38 is removed and fed to separation tanks 74 where hydrogen gas is separated from alkaline seawater 20. Hydrogen 18 is removed from each separation tank 74 by a vacuum pump 60 after which it is purified by passing it through moisture trap 62 and silica gel 79. The purified hydrogen 18 then passes through a mass flow meter 66 and a % hydrogen meter 68.

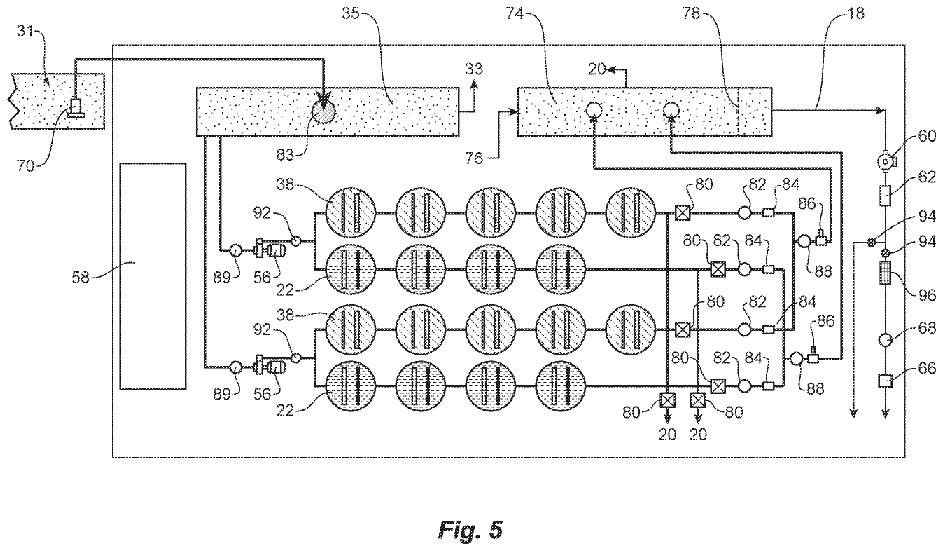

A further alternative version of the apparatus shown in FIG. 4 is shown in FIG. 5. This version may be suitable for mounting on a truck or in a shipping container for example. It can be positioned near carbon emitters to demonstrate the production of hydrogen while sequestering their carbon emissions.

Again, seawater is fed into the apparatus of FIG. 5 via seawater pump 70 placed in the ocean 31. The seawater 30 passes through a screen 83 and into pump box 35 where raw filtered seawater is stored. Excess seawater 33 is allowed to drain away. From pump box 35 the seawater passes via valve 56 into the bottom of each cathode cell 22 and each anode cell 38. Flow of seawater is controlled by valves 89 and 92. Hydrogen 18 produced at each cell is removed and flow is controlled by ball valves 80 Alkaline seawater 20 is also removed using ball valves 80. Pressure valves 82 and Maric valves 84 at 150 lpm are also used to control flow of hydrogen. The pH and Cl content are measured using pH meter 88 and chlorine meter 86 respectively. The hydrogen 18 gas is then fed to separation tank 74 where it is separated from alkaline seawater 20. Hydrogen 18 is removed from each separation tank 74 by passing an inert gas 76 such as nitrogen through the separation tank 74. A baffle 78 is used to prevent egress of alkaline seawater 20 from the tank and into the hydrogen off take lines. The hydrogen 18 produced is then removed by a vacuum pump 60 after which it is purified by passing it through moisture trap 62 and dessicant 96. Gas flow at this point is controlled using valves 94. The purified hydrogen 18 then passes through a % hydrogen meter 68 and a mass flow meter 66. The system is powered by a 50 KVA diesel generator 58.

In this embodiment, the cathode electrodes and anode electrodes are copper mesh coated with Hastelloy 276c. The solution electrodes are plate copper or graphene coated with ruthenium-iridium alloy or oxides.

To achieve higher hydrogen generation capacity, the current needs to be increased and this requires an increase in the cell voltage. With the diaphragm-less cells described in the above embodiments, increasing the cell voltage above a certain point may result in the production of oxygen and chlorine in the same cell where the hydrogen is produced. To avoid this, membrane type cells as described in U.S. Pat. No. 10,316,416 can be used but instead of an alkaline electrolyte at the anode cell and acid electrolyte at the cathode cell, only alkaline seawater is passed through the anode cell and the cathode cell. The electrodes and the membrane are made of a conductive material such as copper or graphene coated with a catalyst that also acts as protection against corrosion. The conductive membrane allows only electrons to pass so that hydroxide ions accumulate at the cathode and H⁺ ions accumulate at the anode. Thus, the seawater exiting the cathode cells is electrically negative while the seawater exiting the anode cells is electrically positive. When these seawaters are passed through another set of neutralizing cells, the electrolytes are neutralised and current flows and, according to Faraday, another lot of oxygen and hydrogen are produced.

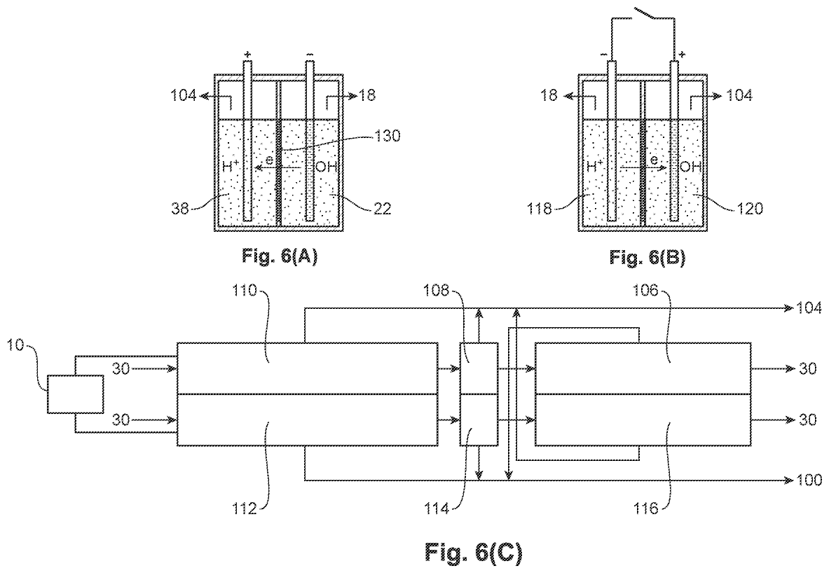

As shown in FIG. 6(A), in membrane cell seawater electrolysis, the seawater is alkaline In this embodiment, the apparatus comprises a cathode cell 22 and an anode cell 38 separated by a membrane 130. The overall cell potential E₀=1.229 volts, the anode cell 38 potential E₀=0.401 volts and the cathode cell 22 potential E₀=0.828 volts. Hydrogen 18 is produced at the cathode cell 22 and hydroxide ions build up while oxygen 104 is produced at the anode cell 38 and H⁺ ions build up. The anolyte becomes positive whilst the catholyte becomes negative.

After treatment in the charging cells, the electrolytes are de-gassed and then fed to neutralising cells as shown in FIG. 6(B). In the neutralising cell, the electrolyte 118 is positive whilst the electrolyte 120 is negative. Current flows according to Faraday and more hydrogen 18 and oxygen 104 are produced.

A system comprising charging cells of FIG. 6(A) and neutralising cells of FIG. 6(B) is shown in FIG. 6(C). Seawater 30 is fed into charging cells comprising anode cells 110 and cathode cells 112. The anode cells 110 and cathode cells 112 are electrically connected to a DC power supply 10. Oxygen 104 generated in the anode cells 110 is separated at oxygen off take 108 whilst hydrogen 18 generated in the cathode cells 112 is separated at hydrogen off take 114. The anolyte 118 and the catholyte 120 then pass to short circuited neutralising cells comprising anode cell 106 and cathode cell 116. Hydrogen 18 is produced in anode cell 106 and oxygen 104 is produced in cathode cell 116. Waste seawater 30 is removed from each cell.

The apparatus and processes described herein can be used for the commercial production of pure hydrogen from seawater that will be a major boost in the use of hydrogen to replace carbon fuels. It will allow hydrogen to be produced in many parts of the world so long as there is seawater available.

It will be understood that the terms “comprise” and “include” and any of their derivatives (eg comprises, comprising, includes, including) as used in this specification is to be taken to be inclusive of features to which the term refers, and is not meant to exclude the presence of any additional features unless otherwise stated or implied

The reference to any prior art in this specification is not, and should not be taken as, an acknowledgement of any form of suggestion that such prior art forms part of the common general knowledge.

It will be appreciated by those skilled in the art that the disclosure is not restricted in its use to the particular application or applications described. Neither is the present disclosure restricted in its preferred embodiment with regard to the particular elements and/or features described or depicted herein. It will be appreciated that the disclosure is not limited to the embodiment or embodiments disclosed, but is capable of numerous rearrangements, modifications and substitutions without departing from the scope as set forth and defined by the following claims

1. An apparatus for electrolysing seawater to produce hydrogen, the apparatus comprising a unipolar electrolytic cell configured to operate in cathode-cathode mode and configured to reduce the production of chlorine and/or oxygen.

2. The apparatus according to claim 1, wherein the apparatus is configured to reduce the production of chlorine and/or oxygen by reducing the voltage at the cathode and/or anode.

3. The apparatus according to claim 2, comprising one or more resistors to reduce the voltage at the cathode and/or anode.

4. The apparatus according to claim 2, comprising:
a cathode cell comprising a cathode electrode and a cathode cell solution electrode; and
an anode cell comprising an anode electrode and an anode cell solution electrode;
wherein cell gaps between the cathode electrode and a cathode cell solution electrode and the anode electrode and an anode cell solution electrode are set to reduce the voltage at the cathode and/or anode.

5. The apparatus according to claim 3, comprising:
multiple anode cells connected in series, each anode cell having a gap between electrodes; and
multiple cathode cells connected in series, each cathode cell having a gap between electrodes
wherein the gap between electrodes in the cathode cell is larger than the gap between electrodes in the anode cell.

6. The apparatus according to claim 5, wherein the cathode cells and the anode cells are diaphragm-less electrolytic cells connected in cathode mode.

7. The apparatus according to claim 6, wherein the cathode cells and the anode cells are fitted with low electrical resistance electrodes coated with at least one catalyst.

8. The apparatus according to claim 5, comprising diaphragm-less electrolytic cells where there are more anode cells with smaller gaps between electrodes and less cathode cells with larger gaps between the electrodes.

9. The apparatus according to claim 8, wherein the apparatus comprises five anode cells with electrode gaps of 4 mm and four cathode cells with electrode gaps of 6 mm.

10. The apparatus according to claim 5, wherein the electrodes of the diaphragm-less electrolytic system are made of high electrical conductivity material and coated with a protective coating and/or a catalyst coating.

11. The apparatus according to claim 10, wherein the high electrical conductivity material is selected from the group consisting of copper and graphene.

12. The apparatus according to claim 10, wherein the catalyst coating comprises Hastelloy 276c.

13. The apparatus according to claim 10, wherein the protective coating comprises ruthenium/iridium metal or and oxide thereof.

14. The apparatus according to claim 1, comprising a cathode cell and an anode cell and a membrane between the anode cell and the cathode cell, the membrane configured to allow only electrons to pass from cathode cell to the anode cell resulting in the cathode electrolyte becoming electrically negative while the anode electrolyte becoming electrically positive and further comprising another set of electrolytic cells through which the electrically negative cathode electrolyte and the electrically positive anode electrolyte can be passed to generate a current and produce hydrogen and oxygen.

15. The apparatus according to claim 1, wherein the cathode-cathode mode comprises an electrical connection where the negative of a DC supply is connected to the cathode electrode, the cathode solution electrode connected to the anode electrode and the positive of the DC supply is connected to the anode solution electrode.

16. A process for producing hydrogen from seawater, the process comprising introducing seawater into an apparatus according to claim 1 and producing hydrogen therefrom.
